(19) United States
(12) Patent Application Publication
(10) Pub. No.: US 2025/0062352 A1
(43) Pub. Date: Feb. 20, 2025

(54) ANODE ACTIVE MATERIAL PRECURSOR FOR LITHIUM SECONDARY BATTERY, ANODE ACTIVE MATERIAL INCLUDING SAME, AND METHOD FOR MANUFACTURING SAME

(71) Applicants: POSCO HOLDINGS INC., Seoul (KR); RESEARCH INSTITUTE OF INDUSTRIAL SCIENCE & TECHNOLOGY, Pohang-si, Gyeongsangbuk-do (KR)

(72) Inventors: Gang Ho LEE, Pohang-si (KR); Sei Min PARK, Pohang-si (KR); Jong Hoon YOON, Pohang-si (KR); Yong Jung KIM, Pohang-si (KR); Jang-Yul KIM, Pohang-si (KR)

(73) Assignees: POSCO HOLDINGS INC., Seoul (KR); RESEARCH INSTITUTE OF INDUSTRIAL SCIENCE & TECHNOLOGY, Pohang-si, Gyeongsangbuk-do (KR)

(21) Appl. No.: 18/722,271

(22) PCT Filed: Dec. 6, 2022
(86) PCT No.: PCT/KR2022/019740

§ 371 Date: Jun. 20, 2024

(30) Foreign Application Priority Data
Dec. 21, 2021 (KR) 10-2021-0183666

(51) Int. Cl. H01M 4/587; C01B 32/205; H01M 4/02; H01M 10/0525

(52) U.S. Cl. CPC H01M 4/587; C01B 32/205; H01M 10/0525; C01P 2004/61; H01M 2004/027

(57) ABSTRACT

The present embodiment relates to an anode active material precursor, an anode active material, and a method for manufacturing same. An anode active material precursor according to an embodiment comprises: a carbon-based material comprising a metal compound; and a petroleum-based pitch, wherein the petroleum-based pitch comprises, on the basis of 10 parts by weight of the carbon-based material, 3 to 10 parts by weight, the softening point of the petroleum-based pitch may be 220-280° C., and the content of the metal compound may be greater than or equal to 10 ppm.

### TECHNICAL FIELD

Exemplary embodiments relate to secondary batteries, and more particularly, to an anode active material for lithium secondary batteries, a method for manufacturing the same, and a lithium secondary battery including the same.

### BACKGROUND ART

Lithium secondary batteries generally include a cathode including a cathode active material, an anode including an anode active material, a separator, and an electrolyte and perform charging and discharging by intercalation-decalation of lithium ions. Lithium secondary batteries, having the advantages of high energy density, large electromotive force, and high capacity, have been applied in various fields.

In addition, improving high-temperature performance, such as high-temperature storage characteristics and high-temperature cycling characteristics, in lithium secondary batteries is an important problem to be solved. For example, after the anode active material is applied to a current collector and rolled, if a total internal pore volume is high, there is a high possibility that the high temperature performance of an anode may deteriorate. Therefore, there is a need to improve high-temperature characteristics when developing anode materials for lithium secondary batteries, for example, secondary batteries for rapid charging, by minimizing changes in electrode structure and total internal pore volume that occur during electrode rolling.

In addition, as technology development and demand for mobile devices has increased, demand for secondary batteries as an energy source has rapidly increased. Among secondary batteries, lithium secondary batteries that exhibit high energy density and operating potential, long cycle life, and low self-discharge rate have been commercialized and widely used.

In addition, as interest in environmental issues have grown, interest in electric vehicles and hybrid electric vehicles that may replace vehicles that use fossil fuels, such as gasoline vehicles and diesel vehicles, which are one of the main causes of air pollution, has increased, research has been actively conducted to use lithium secondary batteries as a power source for the electric vehicles and hybrid electric vehicles.

Recently, due to the rapid rise of EV electric vehicles, expectations for lithium secondary batteries have grown, and demand for improving rapid charging characteristics, while preserving the existing capacity, has increased. The role of an anode active material, which is responsible for storing lithium ions during charging, has become important in improving the rapid charging.

As the anode active material, materials, such as metallic lithium anode active material, carbon-based anode active material, or silicon oxide (SiOx) have been used. The carbon-based negative active material exhibits excellent capacity preservation characteristics and efficiency. Since the carbon-based anode active material used as the anode of lithium secondary batteries has a potential close to an electrode potential of lithium metal, a change in crystal structure is small during the intercalation and decalation process of ionic lithium. In addition, the carbon-based anode active material enables continuous and repeated oxidation and reduction reactions in electrodes, allowing lithium secondary batteries to have high capacity and excellent lifespan.

Various types of materials have been used as the carbon-based anode active material, such as natural graphite and artificial graphite, which are crystalline carbon-based materials, or hard carbon and soft carbon, which are amorphous carbon-based materials. Among the carbon-based anode active materials, graphite-based anode active materials, which have excellent reversibility and may improve the lifespan characteristics of lithium secondary batteries, have been most widely used. Since the graphite-based anode active material has a low discharge voltage of −0.2 V compared to lithium, batteries using the graphite-based active material may exhibit a high discharge voltage of 3.6 V, which has an excellent advantage in terms of energy density of lithium secondary batteries.

Artificial graphite, which is a crystalline carbon-based material, creates a graphite crystal structure by applying high heat energy of 2,700° C. or higher, so it has a more stable crystal structure than natural graphite, and since a change in the crystal structure of artificial graphite is small even after repeated charging and discharging of lithium ions, artificial graphite has the advantage of having a lifespan that is 2 to 3 times longer than natural graphite. Soft carbon and hard carbon, which are amorphous carbon-based materials whose crystal structure is not stabilized, have characteristics allowing lithium ions to advance more smoothly and may increase charging and discharging speeds, and thus, soft carbon and hard carbon may be used in electrodes that require rapid charging. Therefore, in consideration of the lifespan characteristics and output characteristics of the lithium secondary battery to be used, it is common to mix the carbon-based materials in a certain ratio.

However, natural graphite, among the graphite-based materials that are the anode active materials, has a problem of low hardness, so a coating treatment is essential to provide hardness. However, there is a problem in that the coating treatment has limitations in manufacturing high-capacity batteries.

### DISCLOSURE

### Technical Problem

The present disclosure attempts to provide an anode active material precursor capable of ensuring high hardness and electrical conductivity.

The present disclosure also attempts to provide an anode active material having the above advantages.

The present disclosure also attempts to provide a method for manufacturing an anode active material having the above advantages.

### Technical Solution

According to an exemplary embodiment, an anode active material precursor includes a carbon-based material including a metal compound and a petroleum-based pitch, wherein 3 to 10 parts by weight of petroleum-based pitch based on 100 parts by weight of the carbon-based material is included, a softening point of the petroleum-based pitch is 220 to 280° C., and a content of the metal compound is 10 ppm or more. The carbon-based material may be at least one of natural graphite, soft carbon, hard carbon, kish graphite, pyrolytic carbon, mesophase pitch-based carbon fiber, mesophase graphite powder, meso-carbon microbeads, mesophase pitches, and coal tar derived cokes.

The carbon-based material may have purity of 97% or more. An average particle diameter (D50) of the carbon-based material may be 13 to 17 μm.

A content of a beta resin of the petroleum-based pitch may be 15 to 40%. The petroleum-based pitch may have a residual mass of 50% or less when measured based on 400° C. The metal compound may be a compound including at least one of metal elements of Fe, Si, Ge, Sn, Pb, P, Sb, Bi, Al, Ga, In, Ti, Mn, Co, Ni, Cu, Zn, Ag, Mg, Sr, and Ba or a mixture thereof.

According to another exemplary embodiment, an anode active material includes: a carbon-based material including a metal compound and a petroleum-based pitch, wherein 3 to 10 parts by weight of petroleum-based pitch based on 100 parts by weight of the carbon-based material is included, a softening point of the petroleum-based pitch is 220 to 280° C., and a content of the metal compound is 10 ppm or more. The anode active material may satisfy the following formula 1.

((Span₂−Span₁)/Span₁)×100≤15% <Formula 1>
(in Formula 1 above, Span₁ is (D90−D10)/D50 of the anode active material, Span₂ is (D90−D10)/D50 after the 1,000 rpm shear force test of the anode active material, and D10, D50, and D90 refer to particle sizes corresponding to 10, 50, and 90% of volume accumulations from the side with a smaller particle size)

According to another exemplary embodiment, a method for manufacturing an anode active material precursor includes: preparing a carbon-based material including 10 ppm or more of a metal compound; adjusting a particle size of the carbon-based material to 13 to 18 μm; introducing 3 to 10 parts) by weight of a petroleum-based binder pitch to the carbon-based material, based on 100 parts by weight of the carbon-based material; and mixing the carbon-based material and the petroleum-based binder pitch, wherein a softening point of the petroleum-based binder pitch is 220 to 280° C.

the adjusting of the particle size of the carbon-based material may include performing pulverization by at least one of physical impact and air flow impact. The mixing of the carbon-based material and the petroleum-based binder pitch may be performed by applying a rotational shear force.

### Advantageous Effects

According to an exemplary embodiment of the present disclosure, the anode active material precursor that exhibits high performance even through low coating film formation by using a high hardness precursor and that is to manufacture an anode material having a high discharge capacity derived from natural graphite by using a thin coating film may be provided.

In addition, according to another exemplary embodiment of the present disclosure, the anode active material including the anode active material precursor having the above advantages may be provided.

In addition, according to another exemplary embodiment of the present disclosure, the method for manufacturing an anode active material having the above advantages may be provided.

### DESCRIPTION OF THE DRAWINGS

FIG. 1 is a flowchart of a method for manufacturing an anode active material precursor according to an exemplary embodiment of the present disclosure.

### MODE FOR INVENTION

Although terms, such as first, second, and third are used for describing various parts, various components, various areas, and/or various sections, the present disclosure is not limited thereto. Such terms are used only to distinguish any part, any component, any area, any layer, or any section from the other parts, the other components, the other areas, the other layers, or the other sections. Thus, a first part, a first component, a first area, a first layer, or a first section which is described below may be mentioned as a second part, a second component, a second area, a second layer, or a second section without departing from the scope of the present disclosure.

Here, terminologies used herein are merely used to describe a specific exemplary embodiment, and are not intended to limit the present disclosure. A singular form used herein includes a plural form as long as phrases do not express a clearly opposite meaning. The term “include” used in the specification specifies specific characteristics, a specific area, a specific integer, a specific step, a specific operation, a specific element, and/or a specific ingredient, and does not exclude existence or addition of the other characteristics, the other area, the other integer, the other step, the other operation, the other element, and/or the other ingredient.

When it is mentioned that a first component is located “above” or “on” a second component, the first component may be located directly “above” or “on” the second component or a third component may be interposed therebetween. In contrast, when it is mentioned that a first component is located “directly above” a second component, a third component is not interposed therebetween.

Although not otherwise defined, all terms used herein, including technical terms and scientific terms, have the same meanings as those generally understood by those skilled in the art to which the present disclosure pertains. Terms defined in a generally used dictionary are additionally interpreted as meanings according with related technical documents and currently disclosed contents, and are not interpreted as ideal meanings or very formal meanings unless otherwise defined.

Hereinafter, an exemplary embodiment of the present disclosure is described in detail. However, the exemplary embodiment is presented as an example and the present disclosure is not limited thereby, and the present disclosure is only defined by the scope of the claims to be described below.

According to an exemplary embodiment of the present disclosure, an anode active material precursor includes a carbon-based material including a metal compound and a petroleum-based pitch. The anode active material precursor is a base material for an anode active material and is required to have high electrochemical properties in order to be used in secondary batteries.

Various carbon-based materials, such as low-crystalline carbon and high-crystalline carbon, may be used as the carbon-based material. The low crystalline carbon may include at least one of soft carbon and hard carbon, and the high crystalline carbon may include carbon-based materials, such as natural graphite, Kish graphite, pyrolytic carbon, mesophase pitch based carbon fiber, mesophase graphite powder (MGP), meso-carbon microbeads, mesophase pitches, and coal tar derived cokes and carbon-based materials, such as artificial graphite, graphitized carbon fiber, and resin sintered body. Specifically, the carbon-based material of the present disclosure may be natural graphite.

In an exemplary embodiment, the carbon-based material may have at least one of flaky, spherical, and blocky shapes. Specifically, the carbon-based material may be spherical natural graphite particles.

In an exemplary embodiment, the carbon-based material includes the above metal compound. The metal compound may be a compound including a metal element of at least one of, for example, Fe, Si, Ge, Sn, Pb, P, Sb, Bi, Al, Ga, In, Ti, Mn, Co, Ni, Cu, Zn, Ag, Mg, Sr, and Ba, or mixtures thereof, and may specifically include Fe.

In an exemplary embodiment, the carbon-based material may include 10 ppm or more of the metal compound. As the metal compound satisfies 10 ppm or more in wt %, an electrical conductivity of 150 s/cm or more may be secured and used as an anode material. If the content is less than the above range, the electrical conductivity may be low, so it may be difficult to apply the metal compound as an anode material.

In an exemplary embodiment, the carbon-based material may have a purity of 97% or more. Specifically, the carbon-based material may have a fixed carbon content of 97% or more. If the carbon-based material has a purity lower than the above purity, performance may deteriorate due to impurities.

In an exemplary embodiment, an average particle diameter (D50) of the carbon-based material may be in the range of 13 to 17 μm. The D50 refers to a particle size corresponding to 50% of a volume accumulation from the side with a smaller particle size. If the average particle size of the carbon-based material is outside an upper limit of the above range, the base material may become excessively large, and there may be a limit to supporting strength due to the limit of the coverage of the binder pitch. If the average particle diameter of the carbon-based material is outside a lower limit of the above range, the specific surface area may be excessively high, an excessive binder pitch may be required, and there is an unavoidable problem of a decrease in battery capacity due to the excessive binder pitch.

The petroleum-based pitch includes 3 to 10 parts by weight based on 100 parts by weight of the carbon-based material. Specifically, 3 to 10 parts by weight of the petroleum-based pitch is further included in the carbon-based material based on extrapolation.

If the content of the petroleum-based pitch is outside upper and lower limits of the range, when an anode material is manufactured using a an anode active material precursor including the petroleum-based pitch, an increase rate of a span value after a shear force test of the anode material with respect to the span value of the anode material may become excessively high. When the increase rate of the span value is excessively high, fine powder is generated excessively, a coating layer may be peeled off, and the particles are separated. Specifically, as the adhesion between a coating material and a surface of the base material decreases, the function as an anode active material may deteriorate.

In an exemplary embodiment, a softening point of petroleum-based pitch satisfies the range of 220 to 280° C. Since the softening point satisfies the above range, there is an advantage in that the function as an anode active material is excellent. If the above range is not satisfied, the increase rate of the aforementioned span value may become excessively high, causing a problem in which the coating layer may be peeled off and particles may be separated.

In an exemplary embodiment, a residual weight at 400° C. may be 50% or less based on the weight of the petroleum-based pitch. If the residual weight is greater than 50%, battery efficiency may be reduced because intercalation and decalation of lithium ions are disadvantageous during battery manufacturing due to an increase in amorphous carbon structure.

In an exemplary embodiment, the petroleum-based pitch may have a beta resin content of 15 to 40 wt %. The beta resin may serve as an adhesive when manufacturing anode materials.

According to another exemplary embodiment of the present disclosure, the anode active material is an anode active material for a lithium secondary battery manufactured by heat-treating the anode active material precursor described above. The anode active material of the present disclosure satisfies Formula 1 below.

((Span₂−Span₁)/Span₁)×100≤15% <Formula 1>
(in Formula 1 above, Span₁ is (D90−D10)/D50 of the anode active material, Span₂ is (D90−D10)/D50 after the 1,000 rpm shear force test of the anode active material, and D10, D50, and D90 refer to particle sizes corresponding to 10, 50, and 90% of volume accumulations from the side with a smaller particle size)

The Span₁ may be a span value when an anode active material is prepared by carbonizing the aforementioned anode active material precursor. For example, the carbonization may be performed at a temperature range of 900° C. or higher. The Span₂ may be a measurement of a change in the span value after performing a shear force test on the anode active material.

If the value of Formula 1 does not satisfy the above range, there is a problem in that excessive fine powder is generated, which causes the coating layer to be peeled off and the particles to be separated. Specifically, there is a problem in that the adhesion between the coating material and the surface of the base material is lowered, thereby deteriorating the function as an anode active material.

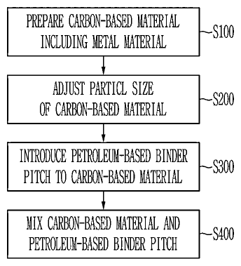

FIG. 1 is a flowchart of a method for manufacturing an anode active material precursor according to an exemplary embodiment of the present disclosure.

Referring to FIG. 1, the method includes preparing a carbon-based material including a metal compound (S100), adjusting a particle size of the carbon-based material (S200), introducing a petroleum-based binder pitch to the carbon-based material (S300), and mixing the carbon-based material and the petroleum-based binder pitch (S400). Detailed descriptions of the carbon-based material, the petroleum-based binder pitch, and the metal compound may refer to the descriptions of the aforementioned anode active material precursor and the anode active material to the extent that they do not contradict.

In the operation of preparing a carbon-based material including a metal compound (S100), a carbon-based material including a 10 ppm or more of metal compound may be prepared. As the metal compound is contained in the amount of 10 ppm or more, it may be used as an anode material having excellent electrical conductivity.

In the operation of adjusting the particle size of the carbon-based material (S200), the particle size of the carbon-based material may be adjusted to 13 to 18 μm. The operation of adjusting the particle size of the carbon-based material (S200) may be controlled by physical impact. For the physical impact, equipment that utilizes physical impact, such as a jetmill, air classifier mill, or roller mill may be utilized. The jetmill directly pulverizes particles using collisions between particles, the air classifier mill pulverizes particles using air flow, and the roller mill injects, compresses, and pulverizes particles between two or more rollers rotating in the opposite directions, thereby pulverizing particles.

The operation of introducing a petroleum-based binder pitch to the carbon-based material (S300) may include introducing 3 to 10 parts by weight of the petroleum-based binder pitch based on 100 parts by weight of the carbon-based material. By satisfying the above range, the increase rate of the aforementioned span value may be prevented from becoming excessively high.

In the operation of mixing the carbon-based material and the petroleum-based binder pitch (S400), mixing methods, such as dry or wet, may be used. Specifically, the operation of mixing the carbon-based material and the petroleum-based binder pitch (S400) may be performed by at least one of a method using air flow, a granulation spheronization method, and a mechanical milling method.

The method using the air flow may be mixing through friction between a wall surface and the anode active material precursor by an air flow using centrifugal force. The granulation spheronization method is a method in which pulverization and granulation are carried out simultaneously and may include a dry method in which pulverized particles are treated by a blade mill, a multi-purpose mixer grinder, or a combination of these milling methods, and a wet method using spray drying. The mechanical milling method is a method in which two or more rollers rotate in a vertical direction by causing friction and the carbon-based material and the petroleum-based binder pitch may be milled and mixed.

The operation of mixing the carbon-based material and the petroleum-based binder pitch (S400) may include forming a coating layer. The coating layer may be a mixture of the carbon-based material and the petroleum-based binder pitch, and the petroleum-based binder pitch may be coated on a surface of the carbon-based material.

In an exemplary embodiment, after mixing the anode active material precursor and a coating material to form the coating layer, shear and/or compressive force may be applied. The shear and/or compressive force may be applied as an external force so that the coating material is disposed on the surface of the anode active material precursor.

According to another exemplary embodiment of the present disclosure, a lithium secondary battery may include a cathode including a cathode active material, an anode including an anode active material, and a separator and an electrolyte solution located between the cathode and the anode.

The cathode may be any one of the group consisting of LiCoO₂, LiNiO₂, LiNiₓMn_{y}O₂, Li_{1+z}NiₓMn_{y}CO_{1-x-y}O₂, LiNiₓCo_{y}Al_{z}O₂, LiV₂O₅, LiTiS₂, LiMoS₂, LiMnO₂, LiCrO₂, LiMn₂O₄, LiFeO₂, LiFePO₄, and combinations thereof, in which x may be 0.3 to 0.8, y may be 0.1 to 0.45, and z may independently be 0 to 0.2. The cathode may be more specifically LiFePO₄, LiCoO₂, NCM811, and NCM622.

The anode may use an anode active material, an anode active material, or an anode active material manufactured by using the anode active material precursor manufactured through the method for manufacturing the anode active material precursor.

As the separator, a conventional porous polymer film used as a separator, for example, a porous polymer film formed of polyolefin-based polymers, such as ethylene homopolymer, propylene homopolymer, ethylene/propylene copolymer, ethylene/butene copolymer, ethylene/hexene copolymer, and ethylene/methacrylate copolymer may be used alone or a stack thereof may be used, or conventional porous non-woven fabrics, such as high-melting point glass fibers, polyethylene terephthalate fibers, etc., may be used, and this is a non-limiting example.

In the electrolyte solution, as lithium salts that may be included as the electrolyte, those commonly used in electrolyte solutions for lithium secondary batteries may be used without limitations, and for example, anions of the lithium salt may be one selected from the group consisting of F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, and (CF₃CF₂SO₂)₂N.

In the electrolyte solution, as organic solvents, organic solvents commonly used in electrolyte solutions for lithium secondary batteries may be used without limitations, and representatively, one selected from the group consisting of propylene carbonate (PC), ethylene carbonate (EC), diethyl carbonate (DEC), dimethyl carbonate (DMC), ethylmethyl carbonate (EMC), methylpropyl carbonate, dipropyl carbonate, dimethyl sulfuroxide, acetonitrile, dimethoxyethane, diethoxyethane, vinylene carbonate, sulfolane, gamma-butyrolactone, propylene sulfite, and tetrahydrofuran, or two or more mixtures thereof may be used.

The lithium secondary battery may be placed in a battery case. The battery case is a non-limiting example and may be any one of a cylindrical type using a can, a prismatic type, a pouch type, and a coin type.

Hereinafter, exemplary embodiments of the present disclosure are described in detail so that those skilled in the art may easily implement the present disclosure. However, the present disclosure may be implemented in various different forms and is not limited to the exemplary embodiments described herein.

### <Precursor of Negative Active Material>

In the following examples and comparative examples, the electrical conductivity of the anode material according to the content of iron (Fe) particles is shown based on 25° C., natural graphite spheroidized particles, D50 of 16 μm, and density of 1.8 g/cc. Specifically, the content of iron particles was measured through inductively coupled plasma (ICP).

TABLE 1

| | | | Added | Electrical | |
|---|---|---|---|---|---|
| | D50 | Density | amount of Fe | conductivity | |
| number | [μm] | [g/cc] | [ppm] | [s/cm] | Remark |
| 1 | 16 | 1.8 | 6 | 50 | Comparative |
| | | | | | Example 1 |
| 2 | 16 | 1.8 | 11 | 200 | Example 1 |
| 3 | 16 | 1.8 | 20 | 240 | Example 2 |
| 4 | 16 | 1.8 | 24 | 310 | Example 3 |
| 5 | 16 | 1.8 | 30 | 290 | Example 4 |

Referring Table 1 above, it can be seen that, when the iron (Fe) content is 10 ppm or more, the electrical conductivity of the anode material is 150 s/cm or more.

### <Negative Active Material>

Table 2 below shows that petroleum-based pitch or coal-based pitch was mixed based on the precursor of a negative electrode active material of Example 1 in Table 1, based on extrapolation as shown in Table 2 below, and then mixed through idling. The mixed material was then carbonized at 1,000° C. for 1 hour to produce an anode active material. Span changes were measured through a shear force test at 1000 rpm. At this time, the span refers to a (D90−D10/D50) value.

TABLE 2

| | spherical shape | | Softening | pitch | | Span after | Increase | |
|---|---|---|---|---|---|---|---|---|
| | natural graphite | | point | content | Span after | shear force | rate of | |
| number | D50 [μm] | pitch type | [° C.] | [wt %] | manufacture | test | span [%] | Remark |
| 1 | 16 | Petroleum-based | 250 | 2 | 0.8 | 1.14 | 42.5 | Comparative |
| | | | | | | | | Example 2 |
| 2 | 16 | Petroleum-based | 250 | 9 | 0.78 | 0.81 | 3.8 | Example 2 |
| 3 | 16 | Petroleum-based | 250 | 11 | 0.82 | 0.95 | 15.9 | Comparative |
| | | | | | | | | Example 3 |
| 4 | 16 | Coal-based | 110 | 3 | 0.97 | 1.31 | 35.1 | Comparative |
| | | | | | | | | Example 4 |
| 5 | 16 | Coal-based | 110 | 10 | 1.03 | 1.57 | 52.4 | Comparative |
| | | | | | | | | Example 5 |
| 6 | 16 | Coal-based | 110 | 12 | 1.02 | 1.55 | 52.0 | Comparative |
| | | | | | | | | Example 6 |

Referring to Table 2 above, it can be seen that, when using the coal-based pitch, the span value increases significantly. In this manner, the span value increases because a large amount of fine powder occurs, and the fine powder occurs because the coating layer is peeled off, the particles are separated, and thus, adhesion between the coating material and the surface of the base material is low. Thus, since the adhesion between the coating material and the surface of the base material is low, there is a problem in that the functionality as an anode active material is reduced.

Referring back to Table 2, when petroleum-based pitch is used, if the pitch content is 2 and 11%, the increase rate of the span value is 15% or more, so there is a problem in that the function as an anode active material is reduced.

Referring to Table 3 below, based on the anode active material precursor of Example 1 in Table 1, a petroleum-based pitch or a coal pitch was mixed based on an extrapolation of 5%, respectively, and then mixed through idling. The mixed material was then carbonized at 1,000° C. for 1 hour to produce an anode active material. Span changes were measured through a shear force test at 1,000 rpm. At this time, the span refers to the value (D90−D10/D50).

TABLE 3

| | | | | pitch content | | Span after | Increase | |
|---|---|---|---|---|---|---|---|---|
| | | | Softening | (extrapolation) | Span after | shear force | rate of | |
| number | D50 [μm] | pitch type | point | [wt %] | manufacture | test | span | Remark |
| 1 | 16 | Petroleum-based | 210 | 5 | 0.79 | 0.97 | 22.8 | Comparative |
| | | | | | | | | Example 7 |
| 2 | 16 | Petroleum-based | 230 | 5 | 0.78 | 0.83 | 6.4 | Example 3 |
| 3 | 16 | Petroleum-based | 250 | 5 | 0.8 | 0.89 | 11.3 | Example 4 |
| 4 | 16 | Petroleum-based | 275 | 5 | 0.76 | 0.84 | 10.5 | Example 5 |
| 5 | 16 | Petroleum-based | 285 | 5 | 0.71 | 0.99 | 39.4 | Comparative |
| | | | | | | | | Example 8 |
| 6 | 16 | Coal-based | 180 | 5 | 0.81 | 1.53 | 88.9 | Comparative |
| | | | | | | | | Example 9 |
| 7 | 16 | Coal-based | 250 | 5 | 1.13 | 1.64 | 45.1 | Comparative |
| | | | | | | | | Example 10 |
| 8 | 16 | Coal-based | 280 | 0 | 1.25 | 1.78 | 42.4 | Comparative |
| | | | | | | | | Example 11 |

Referring to Table 3 above, it can be seen that the coal-based pitch has a large value of a change rate in span value regardless of the softening point. Accordingly, it can be seen that, when batteries are manufactured based on the coal-based pitch, all of the batteries are peeled off.

Referring back to Table 3, it can be seen that, in the case of petroleum-based pitch, the span increase rate is 15% or less only in Examples 2 to 4 in which the softening point is greater than 210 and less than 280. It can be seen that, Comparative Examples 1 and 5 are based on petroleum-based pitch, but since the softening point temperature is outside the range of the present disclosure, the span increase rate is greater than 15%, and peeling is severe during battery manufacturing.

### <Electrochemical Evaluation of Lithium Secondary Battery>

In Table 4 below, when the D50 of spherical natural graphite is 14 μm, the type of pitch is petroleum-based pitch, the softening point is 250° C., and the pitch content is 6%, thermogravimetric analysis (TGA) of the pitch was made in which two types of pitches, specifically coal-based pitch and petroleum-based pitch, were based on residual weight at 400° C. based on weight.

Electrochemical evaluation was conducted through the following process based on Examples and Comparative example shown in Table 4 below.

An anode active material slurry was prepared by mixing 97 wt % of the prepared anode active material, 2 wt % of a binder including carboxymethyl cellulose and styrene butadiene rubber, and 1 wt % of the Super P conductive material in a distilled water solvent. The anode active material slurry was applied to a copper (Cu) current collector and then vacuum dried in a vacuum oven at 100° C. for 12 hours to prepare an anode.

After vacuum drying, an electrode density of the anode was adjusted to 1.5 to 1.7 g/cc. When preparing slurry, an anode material is included as a component, and a series of processes, such as application of copper (Cu), are all applied in the same manner.

Lithium metal (Li-Metal) was used as a counter electrode of the anode manufactured by the above method, and an electrolyte solution obtained by dissolving 1 mole of LiPF₆ solution in a mixed solvent in which a volume ratio of ethylene carbonate (EC) and dimethyl carbonate (DMC) was 1:1 was used.

A 2032 coin cell type half coin cell was manufactured according to a conventional manufacturing method by using each of the above components.

TABLE 4

| | | Softening | | Pitch content | | Span after | Increase | | | |
|---|---|---|---|---|---|---|---|---|---|---|
| | | point | Residual | (extrapolation) | Span after | shear force | rate of | Capacity | Efficiency | |
| Number | Pitch type | [° C.] | weight | [%] | manufacture | test | span [%] | [mAh/g] | [%] | Remark |
| 1 | Petroleum-based | 250 | 53 | 6 | 0.78 | 0.88 | 12.8 | 349 | 83 | Comparative |
| | | | | | | | | | | Example 12 |
| 2 | Petroleum-based | 250 | 49 | 6 | 0.76 | 0.87 | 14.5 | 365 | 91 | Example 7 |
| 3 | Petroleum-based | 250 | 47 | 6 | 0.81 | 0.85 | 4.9 | 359 | 93 | Example 8 |
| 4 | Petroleum-based | 250 | 30 | 6 | 0.85 | 0.88 | 3.5 | 367 | 91 | Example 9 |

Referring to Table 4 above, it can be seen that, when the residual weight exceeds 50%, there is a problem in that the efficiency of the battery decreases. If the residual weight is 50% or more, there is a problem with the intercalation and decalation of lithium ions due to the increase in the amorphous carbon structure.

The exemplary embodiments have been described with reference to the accompanying drawings, but various modifications may be made without being limited thereto and it will be understood by those of skill in the art that various changes in form and details may be made without departing from the spirit and scope of the present disclosure as set forth in the following claims. Therefore, the exemplary embodiments described above are merely illustrative and should not be understood as a limitation of the present disclosure.

1. An anode active material precursor, the precursor comprising:
a carbon-based material including a metal compound and a petroleum-based pitch,
wherein 3 to 10 parts by weight of petroleum-based pitch based on 100 parts by weight of the carbon-based material is included,
a softening point of the petroleum-based pitch is 220 to 280° C., and
a content of the metal compound is 10 ppm or more.

2. The precursor of claim 1, wherein:
the carbon-based material is at least one of natural graphite, soft carbon, hard carbon, kish graphite, pyrolytic carbon, mesophase pitch-based carbon fiber, mesophase graphite powder, meso-carbon microbeads, mesophase pitches, and coal tar derived cokes.

3. The precursor of claim 1, wherein:
the carbon-based material has purity of 97% or more.

4. The precursor of claim 1, wherein:
an average particle diameter (D50) of the carbon-based material is 13 to 17 μm.

5. The precursor of claim 1, wherein:
a content of a beta resin of the petroleum-based pitch is 15 to 40%.

6. The precursor of claim 1, wherein:
the petroleum-based pitch has a residual mass of 50% or less when measured based on 400° C.

7. The precursor of claim 1, wherein:
the metal compound is a compound including at least one of metal elements of Fe, Si, Ge, Sn, Pb, P, Sb, Bi, Al, Ga, In, Ti, Mn, Co, Ni, Cu, Zn, Ag, Mg, Sr, and Ba or a mixture thereof.

8. An anode active material comprising:
a carbon-based material including a metal compound and a petroleum-based pitch,
wherein 3 to 10 parts by weight of petroleum-based pitch based on 100 parts by weight of the carbon-based material is included,
a softening point of the petroleum-based pitch is 220 to 280° C., and
a content of the metal compound is 10 ppm or more.

9. The anode active material of claim 8, wherein:
the anode active material satisfies the following formula 1.
((Span₂−Span₁)/Span₁)×100≤15% <Formula 1>
(in Formula 1 above, Span₁ is (D90−D10)/D50 of the anode active material, Span₂ is (D90−D10)/D50 after the 1,000 rpm shear force test of the anode active material, and D10, D50, and D90 refer to particle sizes corresponding to 10, 50, and 90% of volume accumulations from the side with a smaller particle size)

10. A method for manufacturing an anode active material precursor, the method comprising:
preparing a carbon-based material including 10 ppm or more of a metal compound;
adjusting a particle size of the carbon-based material to 13 to 18 μm;
introducing 3 to 10 parts by weight of a petroleum-based binder pitch to the carbon-based material, based on 100 parts by weight of the carbon-based material; and
mixing the carbon-based material and the petroleum-based binder pitch,
wherein a softening point of the petroleum-based binder pitch is 220 to 280° C.

11. The method of claim 10, wherein:
the adjusting of the particle size of the carbon-based material includes performing pulverization by at least one of physical impact and air flow impact.

12. The method of claim 10, wherein:
the mixing of the carbon-based material and the petroleum-based binder pitch is performed by applying a rotational shear force.
